(19) United States
(12) Patent Application Publication
(10) Pub. No.: US 2006/0291529 A1
(43) Pub. Date: Dec. 28, 2006

(54) Cold wall induction nozzle

(76) Inventors: Robert E. Haun, Coraopolis, PA (US); C. Frederick Yolton, Coraopolis, PA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/434,173

(22) Filed: May 16, 2006

Related U.S. Application Data
(60) Provisional application No. 60/684,550, filed on May 26, 2005.

(51) Int. Cl. H05B 6/22

(52) U.S. Cl. 373/156

(57) ABSTRACT

An induction melting apparatus for the manufacture of gas atomized titanium powder that is free from contamination characteristic of conventional melting practices.

### FIELD OF THE INVENTION

The invention relates to an induction melting apparatus for the manufacture of gas atomized titanium powder that is free from the contamination characteristic of conventional melting practices.

### BACKGROUND OF THE INVENTION

In the conventional manufacture of gas atomized titanium powder, a consumable nozzle is employed. The nozzle is constructed with a cylinder of high purity graphite with an end thereof having a tantalum orifice inserted therein. During the melting operation the graphite cylinder is heated using electro-magnetic induction to the melting temperature of titanium. Since the tantalum orifice has a higher melting point than titanium, it does not melt. As the molten titanium flows through the orifice, however, it erodes the inside surface of the orifice. As the orifice erodes, the resulting molten titanium stream grows larger in diameter. Hence, the molten metal can not be maintained at a constant flow rate and contaminants are introduced to the molten metal stream from the nozzle.

In large-scale production of titanium and titanium alloyed powder of greater than 100 lb. heats, a long life nozzle design is required. Although along with economies of scale which characterize a long life nozzle, sources of contamination such as elemental carbon, elemental tantalum and alumina refractory need to be eliminated to ensure a high purity product. Present conventional practices utilize water-cooled copper crucibles and hearths; however, refractories used to insulate the nozzles employed with these practices are a source of contamination of the resulting atomized titanium alloy powder.

It is accordingly an object of the present invention to provide an apparatus for producing high purity titanium and titanium alloy powder using induction melting to produce a molten mass thereof in a water-cooled copper crucible having a structure that is non-contaminating with respect to the atomized powder.

### SUMMARY OF THE INVENTION

The invention comprises an induction melting apparatus for the manufacture of gas atomized titanium powder having a conductive crucible mounted within a solenoid induction heating coil with a segmented, water-cooled plate mounted in a bottom portion of the crucible.

The segmented water-cooled plate is mounted within a ring-shaped, water-cooled plate in the bottom portion of the crucible. The segmented, water-cooled plate has an orifice in a center portion thereof.

The segmented, water-cooled plate is constructed of a mixture of compacted copper powder and iron powder. The mixture of compacted copper, powder and iron powder is on an outside diameter portion of the segmented, water-cooled plate. The mixture of compacted copper powder and iron powder may be on both an outside diameter portion and a bottom surface portion of the segmented, water-cooled plate.

An induction heating coil may be positioned beneath the segmented, water-cooled plate.

The segmented, water-cooled plate and the induction coil co-act to produce a uniform magnetic field in the orifice.

The segmented, water-cooled plate and the induction coil co-act to produce a magnetic field above the segmented, water-cooled plate.

A metal matrix composite material of copper and iron has been developed yielding a material that is ferromagnetic at room temperature. Using powder metallurgy techniques, small amounts of iron powder are mixed into high conductivity copper powder. The resulting mixture is then blended to produce an even distribution of iron particles in the copper powder. The mixed powder is then pressed together by suitable means at an elevated temperature to produce a 100% dense solid or it can be pressed onto a solid bar or plate of high conductivity copper or inside a hollow cylinder of high conductivity copper to produce a gradient type material. The purpose of this composite is to create a region of high magnetic flux yet still retain the high electrical and thermal conductivity of the copper. Once this material has been inserted into a solenoid or pancake type coil unique magnetic properties can be utilized for industrial purposes such as induction skull melting or flux concentrators used in the materials processing industry.

A water-cooled copper segmented plate has been developed to constrict the flow of molten metal from the bottom of production scale induction skull melting crucible. The plate acts as a secondary inductor when it is placed within a high frequency magnet field produced by a pancake induction coil. By appropriate design, the eddy currents developed within each of the plate segments can be concentrated into a small region (i.e., an orifice) thereby producing a region of very high magnetic field. This field will in turn induce eddy currents within metal located within the orifice and melt it. By virtue of the interaction of the induced eddy currents in the molten metal and the intense magnetic field developed in the orifice region of the segmented plate, the resulting force is inwardly pointing and thereby is able to constrict the molten metal. By appropriate design of the electromagnetic plate, the bottom of a metal mass located within a melting crucible containing a water-cooled bottom, such as a cold wall induction crucible, can be heated and melted in the region above the orifice in the electromagnetic plate. Thus, after first establishing a molten pool in the melting crucible, under which a solid skull naturally forms between the molten pool and the electromagnetic plate, the electromagnetic plate can be energized afterward and used to melt the bottom of the skull in a uniform manner. This molten pool is developed directly above the plate orifice such that the electro-dynamic forces established result in the charge to be, melted from the bottom and up through the center. Once the two molten regions meet, the magnetic field strength developed by the plate can be adjusted to allow levitation of the melt or it can allow the molten metal to flow into the orifice region where it will be constricted by the intense magnetic field developed therein. Further control of the flow of the molten metal can be accomplished by cycling the intensity of the magnetic field in the plate.

Electromagnetic interference between the melting crucible coil and the bottom plate pancake coil is minimized, or eliminated, by inserting the segmented water-cooled bottom plate within a cooled ring of electrically conductive material such as water cooled copper. This ring acts as an electrical shunt thereby isolating the two magnetic fields from each other. Furthermore, the water flowing through this ring can be controlled to influence the surface temperature at the top of the ring. This has added benefit in controlling the skull-thickness of the charge placed within the induction melting crucible.

The accompanying drawings, which are incorporated in and constitute a part of this specification, illustrate one embodiment of the invention and together with the description, serve to explain the principles of the invention.

### BRIEF DESCRIPTION OF THE DRAWINGS

FIG. 1 is a view in vertical cross-section of one embodiment of an induction melting apparatus in accordance with the invention; and

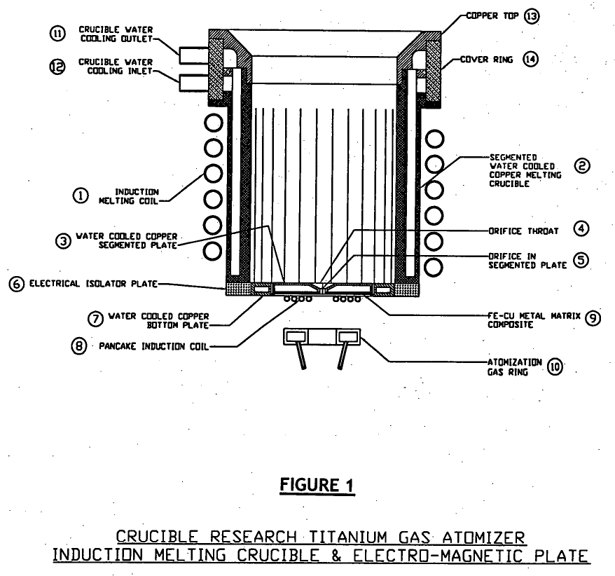

FIG. 1a is a view of the bottom structure of the apparatus.

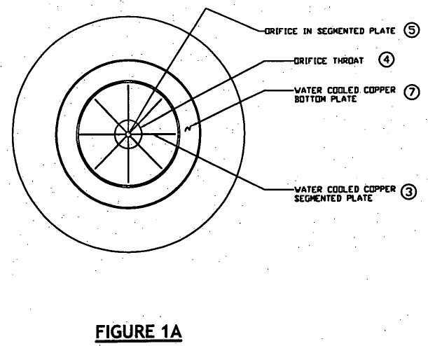

### DESCRIPTION OF THE EMBODIMENTS

Reference will now be made in detail to the present embodiment of the invention, an example of which is illustrated in the accompanying drawings. Wherever possible, the same reference numbers will be used throughout the drawings to refer to the same or like parts.

With respect to the drawings, there is shown a solenoid induction melting coil 1 having therein a segmented water-cooled copper crucible 2. The crucible is fitted with a copper top 13, a covering 14, water inlets 12 and water outlets 1 1 to permit water cooling thereof. A ring-shaped, water-cooled copper bottom plate 7 is located in the open bottom of the crucible 2. A segmented, water-cooled copper plate 3 is located within the opening of the bottom plate 7. An orifice 4 and an orifice 5 are located in the center of the segmented plate 3. An induction coil 8 is located beneath the segmented plate 3. Atomizing gas ring 10 is located below the induction coil 8. This gas ring 10 serves to atomize the molten metal stream which flows from the melting crucible 2 into the orifice 4 of the segmented plate 3 then through the orifice 5 of the segmented plate 3 where the molten stream is constricted by the action of the magnetic field. The resulting powder is collected in a suitable container (not shown) after passing through the atomizing chamber in accordance with well-known conventional practice.

What is claimed is:

1. An induction melting apparatus for the manufacture of gas atomized titanium powder comprising;
a conductive crucible mounted within a solenoid induction heating coil; and
a segmented, water-cooled plate mounted in a bottom portion of said crucible.

2. The apparatus of claim 1, wherein said segmented, water-cooled plate is mounted within a ring-shaped, water-cooled plate in said bottom portion of said crucible.

3. The apparatus of claim 2, wherein said segmented, water-cooled plate has a orifice in a center portion thereof.

4. The apparatus of claim 3, wherein said segmented, water-cooled plate is constructed of a mixture of compacted copper powder and iron powder.

5. The apparatus of claim 4, wherein said mixture of compacted copper powder and iron powder is on an outside diameter portion of said segmented, water cooled plate.

6. The apparatus of claim 5, wherein said mixture of compacted copper powder and iron powder on both an outside diameter portion and on a bottom surface portion of said segmented, water-cooled plate.

7. The apparatus of claim 6, wherein an induction heating coil is positioned beneath said segmented, water-cooled plate.

8. The apparatus of claim 7, wherein said segmented, water-cooled plate and said induction coil co-act to produce a uniform magnetic field in said orifice.

9. The apparatus of claim 8, wherein said segmented, water-cooled plate and said induction coil co-act to produce a magnetic field above said ring-shaped, water-cooled plate.
